(19) United States
(12) Patent Application Publication
(10) Pub. No.: US 2005/0094161 A1
(43) Pub. Date: May 5, 2005

(54) Image forming method and image forming apparatus

(76) Inventors: Tae-hoi Do, Suwon-si (KR); Sun-joo Yoon, Suwon-si (KR)

Correspondence Address: Stanzione & Kim, LLP, 1st Fl., 1740 N St., NW, Washington, DC, 20036, US

(21) Appl. No.: 10/978,537

(22) Filed: Nov. 2, 2004

(30) Foreign Application Priority Data
Nov. 5, 2003 (KR) 2003-78096
Dec. 5, 2003 (KR) 2003-88164

(51) Int. Cl. G06F 3/12

(52) U.S. Cl. 358/1.1; 358/1.15

(57) ABSTRACT

An image forming apparatus which stores and prints or displays data on an external apparatus storing and supplying still images and thumbnail data on the still images, and an image forming method thereof. The image forming method includes receiving external apparatus data from the external apparatus, storing the external apparatus data and thumbnail data on the still images, and printing the external apparatus data and the thumbnail data. In addition, a method of displaying printing record data includes determining whether or not a display of printing record data is requested, and displaying the printing record data if it is determined that the display of the printing record data is requested.

### CROSS-REFERENCE TO RELATED APPLICATIONS

This application claims the priority of Korean Patent Application No. 2003-78096, filed on Nov. 5, 2003, and No. 2003-88164, filed on Dec. 5, 2003 in the Korean Intellectual Property Office, the disclosures of which are incorporated herein in their entirety by reference.

### BACKGROUND OF THE INVENTION

1. Field of the Invention

The present general inventive concept relates to an image forming method and an image forming apparatus, and more particularly, to an image forming apparatus which stores and prints or displays data on an external apparatus, which stores and supplies still images to the image forming apparatus, and thumbnail data on the still images, and an image forming method thereof.

2. Description of the Related Art

Image forming apparatuses, such as printers or multifunction machines, can receive and print still images supplied from external apparatuses which store the still images.

The multifunction machines are widely used as products for providing all functions of a printer, a scanner and a copier. The external apparatuses which store the still images include digital cameras, digital camcorders, mobile phones, digital memory cards, and digital video discs (DVD).

When a printer connected to an external apparatus which stores still images prints the still images, the printer does not separately store data on the external apparatus or the printed still images. Therefore, users could not identify particulars of the printer, such as data on the still images, which have been already printed, and external apparatuses, which have stored the printed still images.

As a result, the users could not identify printing record data on the printer or the multifunction machine, that is, thumbnail data on the printed images, data on the external apparatus which supplies the printed images to the multifunction machine, data on a printing time, the number of printed sheets, printing results, etc. Therefore, there is a disadvantage that the users could not effectively manage the printer or the multifunction machine.

In the meantime, a conventional method of printing text contents and additional data on documents or images to be printed on papers by the printer is disclosed in Korean Patent publication No.: 10-0257825. In the conventional method disclosed in this publication, since the additional data is recorded in a bar code form, a user needs a separate apparatus in order to recognize the additional data. Also, the additional data does not include data on the external apparatus which stores the still images.

### SUMMARY OF THE INVENTION

In order to solve the foregoing and/or other problems, it is an aspect of the present general inventive concept to provide an image forming method of storing and supplying thumbnail data on printed still images and data on an external apparatus which stores the still images.

In order to solve the foregoing and/or other problems, it is another aspect of the present general inventive concept to provide an image forming apparatus to store and supply thumbnail data on printed still images and data on an external apparatus which stores the still images.

In order to solve the foregoing and/or other problems, it is another aspect of the present general inventive concept to provide a method of displaying printing record data, storing the printing record data on printing particulars in a printer, and displaying the stored printing record data on a display unit without using a separate printing unit.

In order to solve the foregoing and/or other problems, it is another aspect of the present general inventive concept to provide an apparatus to display printing record data, to store the printing record data on printing particulars in a printer, and to display the stored printing record data on a display unit without using a separate printing unit.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image forming method in an image forming apparatus which is connected to an external apparatus storing still images and receives and prints the still images from the external apparatus, the method including receiving external apparatus data from the external apparatus, storing the external apparatus data and thumbnail data on the still images, printing the external apparatus data and the thumbnail data.

In an aspect of the present general inventive concept, the method may further include receiving the thumbnail data on the still images from the external apparatus.

In another aspect of the present general inventive concept, the method may further include creating the thumbnail data on the still images in the image forming apparatus.

In yet another aspect of the present general inventive concept, the method may further include determining whether or not the thumbnail data on the still images is received from the external apparatus, and creating the thumbnail data on the still images if the thumbnail data on the still images is not received from the external apparatus.

The foregoing and/or other aspects of the present general inventive concept may also be achieved by providing an image forming apparatus which is connected to an external apparatus storing still images and receives and prints the still images from the external apparatus, the apparatus including an interface unit which receives external apparatus data from the external apparatus, a memory unit which stores the external apparatus data and the thumbnail data on the still images, and a printing unit which prints the external apparatus data and the thumbnail data.

In an aspect of the present general inventive concept, the interface unit may additionally receive the thumbnail data on the still images.

In another aspect of the present general inventive concept, the image forming apparatus may further include a control unit which creates the thumbnail data on the still images.

In yet another aspect of the present general inventive concept, the image forming apparatus may further include a control unit which determines whether or not the thumbnail data on the still images is received from the external apparatus, and which creates the thumbnail data on the still images if the thumbnail data on the still images is not received from the external apparatus.

The foregoing and/or other aspects of the present general inventive concept may also be achieved by providing a method of displaying printing record data, the method comprising steps: (a) determining whether or not display of the printing record data is requested; and (b) displaying the printing record data if it is determined that display of the printing record data is requested.

The foregoing and/or other aspects of the present general inventive concept may also be achieved by providing an apparatus to display printing record data, the apparatus including a display request sensing unit which senses whether or not display of the printing record data is requested, and which outputs the sensed result as a sensing signal, and a printing record data display instruction unit which instructs to display the printing record data in response to the sensing signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image forming apparatus according to an embodiment of the present general inventive concept;

FIG. 2 is a flow chart illustrating an image forming method according to another embodiment of the present general inventive concept;

FIG. 3 is a flow chart illustrating an image forming method according to another embodiment of the present general inventive concept;

FIG. 4 is a flow chart illustrating an image forming method according to another embodiment of the present general inventive concept;

FIG. 5 is a schematic diagram illustrating an example of printing log data according to another embodiment of the present general inventive concept;

FIG. 6 is a flow chart illustrating a method of displaying printing record data according to another embodiment of the present general inventive concept;

FIGS. 7A and 7B are schematic diagrams illustrating examples of the printing record data displayed according to the method shown in FIG. 6; and

FIG. 8 is a block diagram illustrating an apparatus to display printing record data according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

If it is determined that a detailed explanation on related known art or structure in explaining the present invention makes unclear essentials of the present invention, the detailed explanation may omit. Further, the following terms are defined by considering functions of structural elements in the present invention, so that they may change according to an intention or a custom of a user or an operator. Therefore, the definition should fall on the basis of whole contents of the present specification.

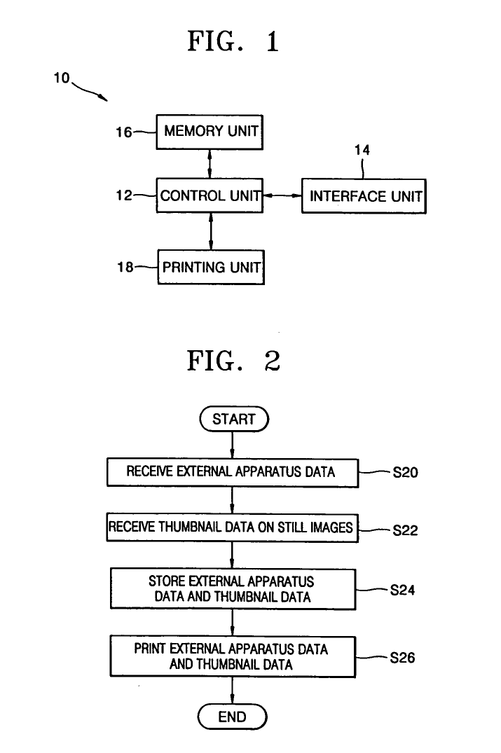

FIG. 1 is a block diagram illustrating an image forming apparatus 10 according to an embodiment of the present general inventive concept. Referring to FIG. 1, the image forming apparatus 10 may include a control unit 12, an interface unit 14, a memory unit 16, and a printing unit 18.

The control unit 12 can be called a central processing unit and can generally control the image forming apparatus 10 based on a program which has been established previously. Particularly, in an aspect of the present general inventive concept, the control unit 12 can determine whether or not thumbnail data on one or more still images is received from an external apparatus and can create the thumbnail data when the thumbnail data is not received. In the meantime, the control unit 12 may create the thumbnail data from the still images without determining whether or not the thumbnail data on the still images is received. When the control unit 12 creates the thumbnail data, the control unit 12 can reduce the still images to a thumbnail form to create the thumbnail data on the still images.

The interface unit 14 connected to the external apparatus which stores the still images can be used to receive the still images. The external apparatus which stores the still images may include a digital camera, a digital camcorder, a mobile phone, a digital memory card or a digital video disc (DVD). In another aspect of the present general inventive concept, the interface unit 14 can receive data on the external apparatus from the external apparatus and the thumbnail data on the still images. In another aspect of the present general inventive concept, the external apparatus data can include a name of the external apparatus.

The memory unit 16 can store a general control program and an operation program of the control unit 12. In this embodiment, the memory unit 16 can store the external apparatus data received from the external apparatus and the thumbnail data.

The printing unit 18 can print the still images received from the external apparatus. In this embodiment, the printing unit 18 can print the external apparatus data, the thumbnail data, and a printing start time of the still images according to a user's request.

An image forming method according to the present general inventive concept may be carried out in an image forming apparatus, which is connected to an external apparatus storing one or more still images and receives the still images from the external apparatus and prints them. When the image forming apparatus receives the still images to be printed from the external apparatus, the image forming apparatus can also receive and store the external apparatus data and thumbnail data on the still images to print them according to a user's request.

Now, Flow charts illustrating the image forming method according to embodiments of the present general inventive concept will be described with reference to FIGS. 2 through 4.

Referring to FIGS. 1 and 2, when a user connects the external apparatus storing the still images to the image forming apparatus, for example, a printer, the printer can receive the external apparatus data from the external apparatus (operation S20).

Then, when the user selects one or more desired still images and requests to print the selected still images, the printer can receive the still images as well as the thumbnail data on the still images (operation S22). At this point, the printer can print the still images.

Next, the external apparatus data and the thumbnail data can be stored in the memory unit 16 of the printer (operation S24). Also, the printing start time of the still image, the number of printed sheets, and the printing result can be stored.

Finally, when the user requests to print printing record data or printing log data, the external apparatus data and the thumbnail data can be printed (operation S26). Also, the printing start time of the still images, the number of printed sheets, and the printing result can be printed together. Here, the printing record data or the printing log data can include the external apparatus data, the thumbnail data on the still images, the printing start time of the still images, the number of printed sheets, the printing result, etc.

In an aspect of the present general inventive concept, the data on the external apparatus can include a characteristic representing the external apparatus, for example, a name of the external apparatus.

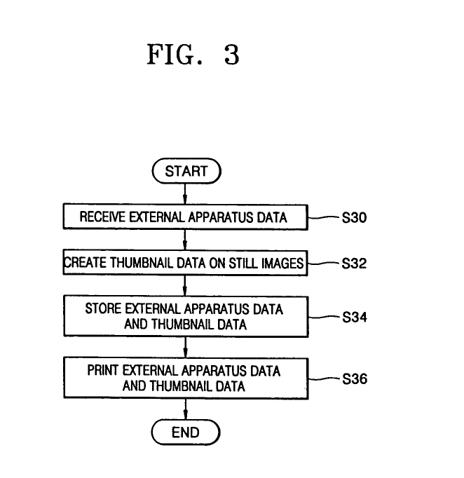

Referring to FIGS. 1 and 3, when the user connects the external apparatus, which stores the still images to the image forming apparatus, for example, a printer, the printer can receive the external apparatus data from the external apparatus (operation S30).

Then, when the user selects one or more desired still images and requests to print the selected still images, the printer can receive and print the still images. The printer can reduce the still images to a thumbnail form to create the thumbnail data on the still images (operation S32).

Next, the external apparatus data and the thumbnail data can be stored in the memory unit 16 of the printer (operation S34). Also, the printing start time of the still images, the number of printed sheets, and the printing result can be stored.

Finally, when the user requests to print the printing record data or the printing log data, the external apparatus data and the thumbnail data can be printed (operation S36). Also, the printing start time of the still images, the number of printed sheets, and the printing result can be also printed together.

In an aspect of the present general inventive concept, the data on the external apparatus can include a name of the external apparatus.

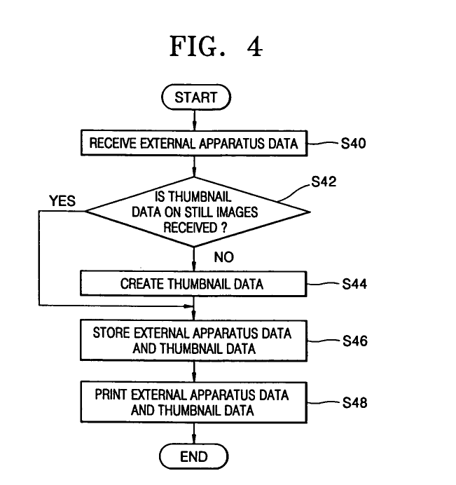

Referring to FIGS. 1 and 4, when the user connects the external apparatus, which stores the still images, to the image forming apparatus, for example, a printer, the printer can receive the external apparatus data from the external apparatus (operation S40).

Then, when the user selects one or more desired still images and requests to print the selected still images, the printer can receive and print the still images. Then, the printer can determine whether or not the thumbnail data on the still images is received from the external apparatus (operation S42). If the thumbnail data is received, operation S46 starts.

If the thumbnail data is not received, the thumbnail data on the still images can be created by reducing the still images to a thumbnail form (operation S44).

Next, the external apparatus data and the thumbnail data can be stored in the memory unit 16 of the printer (operation S46). Also, the printing start time of the still images, the number of printed sheets, and the printing result can also be stored.

Finally, when the user requests to print the printing record data or the printing log data, the external apparatus data and the thumbnail data can be printed (operation S48). Also, the printing start time of the still images, the number of printed sheets, and the printing result can be printed together.

In an aspect of the present general inventive concept, the data on the external apparatus can include a name of the external apparatus.

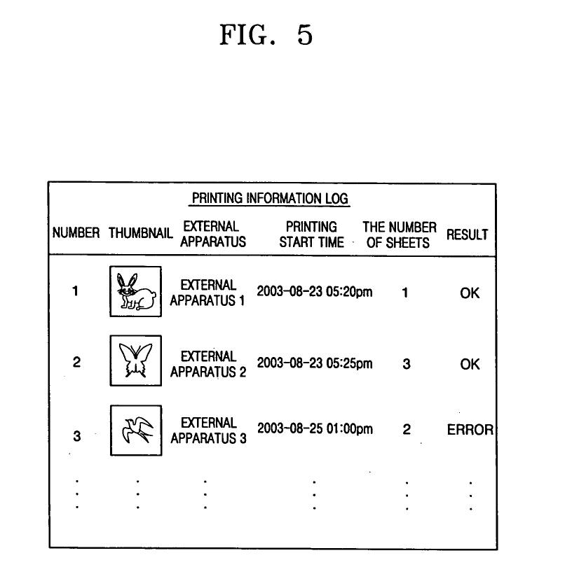

Referring to FIGS. 1 and 5, when the user requests to print the printing log data, the printer can print the printing log data (printing information log) of the still images for a predetermined period as shown in FIG. 5. For example, a thumbnail of the number 1 is a rabbit image. An external apparatus 1 may be, for example, a SAMSUNG mobile phone, SPH-X8000. An external apparatus 2 may be, for example, a SAN_DISK 128M flash memory card. An external apparatus 3 may be, for example, a CANON-G3 digital camera. Also, the printing start time of the still images, the number of printed sheets, and the printing result can be printed together. As a result of this printing process, when the printing process is normally completed, an OK signal can be displayed. On the contrary, when the printing is not normally completed, an error signal can be displayed. The error signal may be displayed when ink or toner lacks.

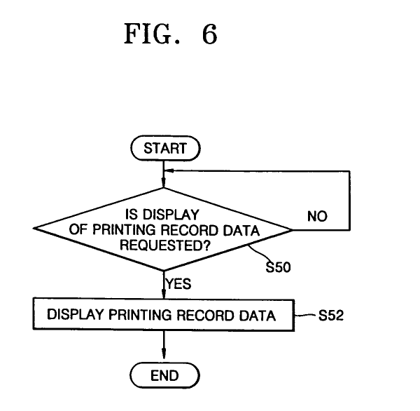

Now, a method of displaying printing record data according to another embodiment of the present general inventive concept will be described with reference to FIGS. 6 through 8.

Referring to FIG. 6, the method can include determining whether or not a display of the printing record data is requested (operation S50), and displaying the printing record data (operation S52).

First, it can be determined whether or not the display of the printing record data is requested (S50). The printing record data can include simple data, such as the thumbnail data on the printed images supplied from the external apparatus or the external apparatus data (for example, a name of the external apparatus). The thumbnail data or the thumbnail images can be referred to as a small size of images reduced from an original size of the original printed images. The printer can receive the printing record data including the simple data and the printed images transmitted from the respective external apparatuses, and can store them in a predetermined storage space for example, the memory unit of FIG. 1. If the thumbnail data on the printed images are not included in the printing record data supplied from the external apparatus, the printer can create and store the thumbnail data corresponding to the printed images. The thumbnail data corresponding to the predetermined printed images can be created by reducing the data sizes of the predetermined printed images. Therefore, since the thumbnail data are created in the forms of tremendously reduced data sizes, it does not require a large data storage space allocated to store the printing record data including the thumbnail data.

The user may request the printing record data from the printer in order to identify a general printer status. In this occasion, it can be determined whether or not the user requests to display the printing record data. If it is determined that display of the printing record data is not requested, operation S50 can be repeatedly executed to continuously monitor whether or not the display of the printing record data is requested.

However, if it is determined that the display of the printing record data is requested, the printing record data can be displayed (operation S52). If the display of the printing record data is requested from the user, the printing record data stored in the printer can be displayed on a display unit of the printer. The method of displaying the printing record data can be variously embodied. For example, the printing record data can be displayed by using an up/down button having a scroll function. The up/down button can comminute with the control unit 12 of FIG. 1, and the display unit can also be connected to the control unit 12 of FIG. 1.

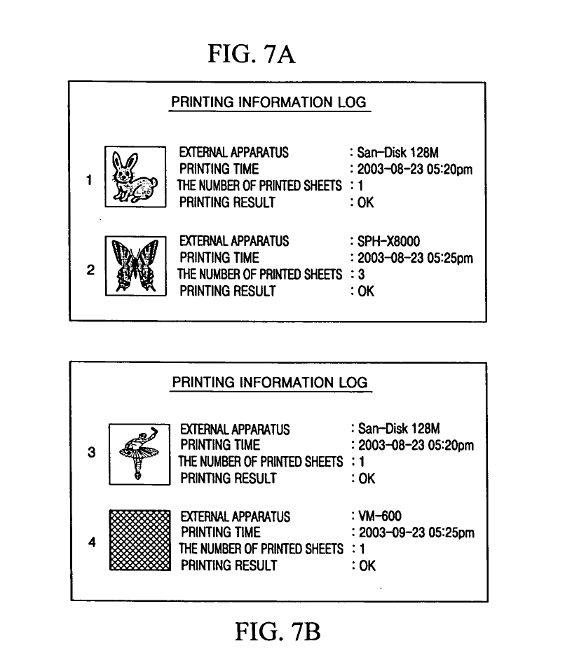

Referring to FIGS. 7A and 7B, the printing record data shown in FIG. 7A can be displayed at the first time. Then, the printing record data shown in FIG. 7B can be displayed according to the user's manipulation of the up/down button.

As shown in FIG. 7A or 7B, from the displayed printing record data, the user can identify various data, such as the thumbnail data on printed images, the external apparatus data (for example, the name of the external apparatus) which supplies the printed images, the printing time of the printed images, the number of printed sheets, and the printing result. Accordingly, by identifying such printing record data, the user can be informed of an operation status of the printer, for example, printer management information to predict replacement times of disposable items, such as a toner, used in the printer, and to replace printer components necessary for the external apparatus at a suitable time.

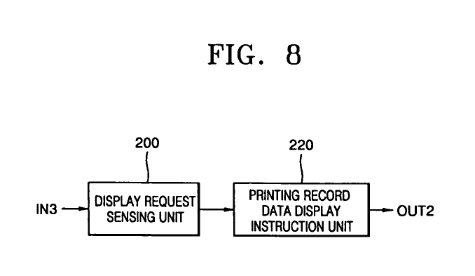

Now, an apparatus to display printing record data according to another embodiment of the present general inventive concept will be described with reference to FIGS. 6 and 8.

Referring to FIGS. 6 and 8, the apparatus may include a display request sensing unit 200 and a printing record data display instruction unit 220.

In order to accomplish operation S50, the display request sensing unit 200 can sense whether or not the display of the printing record data is requested, and can output the sensing result as a sensing signal. That is, the display request sensing unit 200 can sense whether or not a display request signal for the printing record data is input through an input terminal IN3 to determine whether or not the display of the printing record data is requested, and then can output the sensing result as the sensing signal to the printing record data display instruction unit 220.

In order to accomplish operation S52, the printing record data display instruction unit 220 can instruct to display the printing record data in response to the sensing signal. That is, in response to the sensing signal input from the display request sensing unit 200, the printing record data display instruction unit 220 can instruct to display the printing record data stored in a predetermined storage space on a display unit of the printer according to the user's demand for a display method (for example, a scroll type using an up/down button), and outputs the control signal through an output terminal OUT2.

According to an aspect of the present general inventive concept, it is possible to provide the users with various data, such as the thumbnail data on the printed still images, data on the external apparatus which stores the still images, the printing start time of the still images, the number of printed sheets, and the printing result.

In addition, a convenience of the user can be enhanced by providing data on when a certain still image is printed or which external apparatus stores the certain still image.

Furthermore, it is possible to allow the user to suitably manage the printer and reduce toner consumptions because the printing record data are stored in the printer and then displayed on the display unit to notify the user of the same without using a separate printing apparatus.

The exemplary embodiments should be considered in descriptive sense only and not for purposes of limitation. Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image forming method in an image forming apparatus which is connected to an external apparatus storing still images and receives and prints the still images from the external apparatus, the method comprising:
receiving external apparatus data and one or more still images from an external apparatus;
storing the external apparatus data and thumbnail data on the still images; and
printing the external apparatus data and the thumbnail data.

2. The image forming method according to claim 1, wherein the printing of the external apparatus data and the thumbnail data further comprises printing a start time of printing the still images.

3. The image forming method according to claim 1, wherein the external apparatus data comprises a name of the external apparatus.

4. The image forming method according to claim 1, further comprising:
receiving the thumbnail data on the still images from the external apparatus.

5. The image forming method according to claim 1, further comprising:
creating the thumbnail data on the still images in the image forming apparatus.

6. The image forming method according to claim 1, further comprising:
determining whether or not the thumbnail data on the still images are received from the external apparatus; and
creating the thumbnail data on the still images if the thumbnail data on the still images is not received from the external apparatus.

7. The image forming method according to claim 5, wherein the creating of the thumbnail data comprises:
reducing the still images to a thumbnail form.

8. An image forming apparatus which is connected to an external apparatus storing still images and receives and prints the still images from the external apparatus, the apparatus comprising:
an interface unit which receives external apparatus data and one or more still images from an external apparatus;
a memory unit which stores the external apparatus data and thumbnail data on the still images; and
a printing unit which prints the external apparatus data and the thumbnail data.

9. The image forming apparatus according to claim 8, wherein the printing unit prints a start time of printing the still images.

10. The image forming apparatus according to claim 8, wherein the external apparatus data comprises a name of the external apparatus.

11. The image forming apparatus according to claim 8, wherein the interface unit receives the thumbnail data on the still images from the external apparatus.

12. The image forming apparatus according to claim 8, further comprising:
a control unit which creates the thumbnail data on the still images.

13. The image forming apparatus according to claim 8, further comprising:
a control unit which determines whether or not the thumbnail data on the still images is received from the external apparatus and creates the thumbnail data on the still images if the thumbnail data on the still images is not received from the external apparatus.

14. The image forming apparatus according to claim 13, wherein the control unit reduces the still images to a thumbnail form when the control unit creates the thumbnail data.

15. A method of displaying printing record data in a printer which stores the printing record data supplied from an external apparatus which is a digital camera, a digital memory card or a digital camcorder, the method comprising:
determining whether or not a display of the printing record data is requested; and
displaying the printing record data if it is determined that the display of the printing record data is requested.

16. The method of displaying printing record data according to claim 15, wherein the displaying of the printing record data comprises displaying the printing record data in a scroll type.

17. An apparatus to display printing record data in a printer which stores the printing record data supplied from an external apparatus which is a digital camera, a digital memory card or a digital camcorder, the apparatus comprising:
a display request sensing unit which senses whether or not a display of the printing record data is requested and outputs the sensed result as a sensing signal; and
a printing record data display instruction unit which instructs to display the printing record data in response to the sensing signal.

18. The apparatus according to claim 17, wherein the printing record data display instruction unit instructs that the printing record data is displayed in a scroll type.

19. A method of an image forming apparatus, the method comprising:
generating data including one or more images and thumbnail data on the one or more images from an external apparatus;
printing the one or more images in a printing unit; and
storing the thumbnail data in a memory unit when the one or more images are erased after printed.

20. A method of an image forming apparatus, the method comprising:
generating at least one of printing apparatus data and thumbnail data on one or more images to be printed, upon receiving one of a printing request signal and a displaying request signal.

21. An image forming apparatus comprising:
a control unit to generate at least one of printing apparatus data and thumbnail data on one or more images to be printed, upon receiving one of a printing request signal and a displaying request signal.
